(19) United States
(12) Patent Application Publication
(10) Pub. No.: US 2015/0269297 A1
(43) Pub. Date: Sep. 24, 2015

(54) METHODS FOR REDUCING POST LAYOUT CIRCUIT SIMULATION RESULTS

(71) Applicant: G-Analog Design Automation Limited, Hsinchu City (TW)

(72) Inventor: Jeh-Fu Tuan, San Jose, CA (US)

(73) Assignee: G-Analog Design Automation Limited, Hsinchu City (TW)

(21) Appl. No.: 14/219,947

(22) Filed: Mar. 19, 2014

(51) Int. Cl. G06F 17/50

(52) U.S. Cl. CPC G06F 17/5045; G06F 17/5036

(57) ABSTRACT

A method for reducing the size of post-layout circuit simulation output waveform database without a loss of essential information and accuracy. The reduced waveform database requires significantly less storage than the typical waveform database for post-layout simulation, thereby improving the time required for a waveform tool to access, and for a user to navigate, the post-layout simulation results. The method therefore greatly improves designer productivity during circuit verification and debugging phases. The method can be carried out in a preprocessor to a circuit simulator, in a post-processor to a circuit simulator, or may be directly built into a circuit simulator. The method is applicable to any post-layout netlists with schematic node names or circuit element names.

### BACKGROUND OF THE INVENTION

1. Field of the Invention

The present invention relates to post-layout circuit simulation. In particular, the present invention relates to techniques that reduce the size of a post-layout circuit simulation output waveform database, without loss of essential information and accuracy.

2. Discussion of the Related Art

As the feature sizes of an integrated circuit (IC) decrease, and as circuit density and performance increase, circuit simulation has become a critical aspect of ensuring that the IC meets requirements. However, as IC technology continues to advance, circuit simulation continues to require greater computing resources and time. Consequently, circuit verification and debugging based on circuit simulation results have become the bottleneck in the design process of ICs.

In the IC design flow, a pre-layout circuit simulation primarily verifies circuit functionality and performs a first-pass circuit optimization. Because pre-layout circuit simulations are performed prior to layout, a pre-layout circuit description (“netlist”) contains only the design circuit elements. A pre-layout netlist is typically extracted from a schematic capture design environment, where the circuit designers draw the schematic circuits. As the ICs incorporate ever smaller features, layout-related effects have become increasingly important. These layout effects result from, for example, such parameters as capacitance, resistance, inductance, cross-talk, or resistive voltage drop in the realized circuit elements. A post-layout netlist may have many times the number of circuit elements than the corresponding pre-layout netlist. Thus, a post-layout circuit simulation is typically significantly slower than the corresponding pre-layout circuit simulation. A post-layout circuit simulation not only ensures that circuit functionality is maintained during the layout process, it also ensures that the circuit elements to be fabricated meet timing and power requirements.

There are three netlist formats that are widely used in the industry to represent a post-layout netlist; namely, the SPICE, SPEF and DSPF netlists. The SPICE netlist is the most commonly used netlist format for circuit simulation. SPICE—which stands for Simulation Program with Integrated Circuit Emphasis—is a circuit simulator originally developed at the University of California, Berkeley. The latest version of SPICE is referred to as “SPICE3.” SPICE is typically used for general circuit simulation, including DC analysis, AC analysis, operating point analysis, transient analysis and many other circuit analyses using such circuit elements as voltage or current sources, resistors, capacitors, inductors, metal-oxide-semiconductor field effect transistors (MOSFETs), bipolar junction transistors (BJTs), diodes and other circuit elements. Many commercial circuit simulators are based on the original SPICE program. Thus, the SPICE netlist format is considered an industry standard and is supported by most circuit simulators. Although subsequent circuit simulators have extended the SPICE format to support additional features, the basic SPICE netlist format remains unchanged over the years.

The SPEF netlist is not SPICE-compatible, in that it cannot be read directly by most circuit simulators. The SPEF netlist may be used to provide back-annotation to the original pre-layout netlist that is used for digital logic simulation. As the SPEF netlist is not suitable for analog circuit simulation, the SPEF netlist is not further considered here.

DSPF—which stands for “Detailed Standard Parasitic Format”—is a post-layout netlist format that provides in a SPICE file format parasitic resistors and capacitors for each pre-layout net. An exemplary DSPF file may read:

*|DSPF 1.0
*|DESIGN “BUF”
*|DIVIDER/
*|DELIMITER :
.subckt BUF A Z VSS VDD
*|GROUND_NET 0
*
* Net Section
*
*|NET A 4.0e−14
*|I (M2:g M2 g I)
*|I (M3:g M3 g I)
*|P (A X 0.0)
*|S (A:1)
c0 A:1 0 10f
c1 A 0 10f
c2 M3:g 0 10f
c3 M2:g 0 10f
r0 A A:1 1000
r1 A:1 M3:g 100
r2 A:1 M2:g 100
*|NET INT 6.0e−14
*|I (M0:g M0 g I)
*|I (M1:g M1 g I)
*|I (M2:s M2 s B)
*|I (M3:s M3 s B)
*|S (INT:1)
*|S (INT:2)
c4 INT:1 0 10f
c5 M2:s 0 10f
c6 M3:s 0 10f
c7 INT:2 0 10f
c8 M1:g 0 10f
c9 M0:g 0 10f
r3 M3:s INT:2 100
r4 M2:s INT:2 100
r5 INT:2 INT:1 1000
r6 INT:1 M1:g 100
r7 INT:1 M0:g 100
*|NET VSS 1e−13
*|NET VDD 1e−13
*|NET Z 4.0e−14
*|I (M0:d M0 d B)
*|P (Z X 0.0)
*|I (M1:d M1 d B)
*|S (Z:1)
c10 M1:d 0 10f
c11 Z 0 10f
c12 M0:d 0 10f
c13 Z:1 0 10f
r8 Z:1 M1:d 100
r9 M0:d Z:1 100
r10 Z:1 Z 1000
*
* Instance Section
*
M2 M2:s M2:g VSS VSS NMOS L=6e−08 W=3.5e−07
M0 M0:d M0:g VSS VSS NMOS L=6e−08 W=7e−07
M3 M3:s M3:g VDD VDD PMOS L=6e−08 W=5e−07
M1 M1:d M1:g VDD VDD PMOS L=6e−08 W=10e−07
*
.ends

A DSPF netlist embeds non-standard SPICE format statements in comment lines that begin with ‘*|’, such as:

### *|I(InstancePinName InstanceName PinName PinType PinCap X Y)

### *|P(PinName PinType PinCap X Y)

### *|NET NetName NetCap

### *|S(Sub-nodeName X Y)

### *|GROUND_NET NetName

The following DSPF directives are relevant to understanding the following detailed description: “NET”, “P”, “I”, and “S.” The “NET” directive begins a new net description, and is associated with a “NetName” parameter and a “NetCap” parameter. The “NetName” parameter provides a unique name for the net, which normally corresponds to a pre-layout node name. The “NetCap” parameter provides a total capacitance for the net identified by the NetName. The “P” directive denotes a pin of a net, and is associated with a “PinName” parameter and a “PinType” parameter. The “PinName” parameter provides a name for the pin, and the “PinType” provides the pin type, which may be “I” (for input), “O” (for output) or another identifier for an approved pin type. The “I” directive denotes an instance pin of a net, and is associated with (a) the “InstancePinName” parameter, which provides a name for the instance pin; (b) the “InstanceName” parameter, which provides a name for an element instance to which the instance pin identified by the “InstancePinName” parameter is connected to; (c) the “PinName” parameter provides a name for the pin in the element instance identified by the “InstanceName” parameter that connects to the instance pin identified by the “InstancePinName” parameter, and (d) the “PinType” parameter, which can be “D” (for drain), “S” (for source), and “G” (for gate) when used with an MOS transistor, but may receive other values, when used with any of numerous other types for circuit elements. The “S” directive denotes a sub-node of a net, and is associated with the “Sub-nodeName” parameter, which provides a name for the sub-node. A sub-node is neither a pin nor an instance pin.

The DSPF netlist format can be used to back-annotate a pre-layout netlist to allow post-layout circuit simulations. However, the back-annotation approach may be too error-prone for many applications, as back-annotation does not handle cross-talk capacitance or device back-annotation efficiently and correctly, especially for custom-designed circuits that have high simulation accuracy requirements. For a custom-designed circuit, a DSPF or a SPICE netlist that is not a back-annotation of a pre-layout netlist is preferred.

Post-layout simulations can take up to hours, days or even weeks to complete. Numerous methods have been invented to speed up the simulation. Most methods are based on reducing the parasitic circuit elements (“parasitic reduction”) or the number of circuit elements, either during circuit simulation or during a pre-processing step for the circuit simulation. Parasitic reduction methods use either an ad hoc method (e.g., parallel, series reduction or filters), or a mathematical method (e.g., model order reduction (“MOR”)). Methods aimed at reducing the number of circuit elements are often used for simulating memory circuits, since the post-layout netlists may contain arrays of memory cells that are not exercised during the simulation. These methods all suffer some accuracy loss, as the reduction ratio is always traded-off with error minimization. In a method where the reduction technique is applied outside the simulator, the errors may be quantified by comparing the results before and after application of the reduction technique. However, in a method where the reduction technique is applied within the circuit simulator, the errors are more difficult to quantify, as how the reduction algorithm affect the results cannot not be readily ascertained. Most designers prefer a circuit reduction algorithm that achieves better circuit simulation performance within certain accuracy limits.

In the prior art, a post-layout circuit simulation is performed using a flattened netlist. The flattened netlist uses either index numbers or flattened hierarchical names to represent the circuit elements and the nodes. Such forms of identification are very tedious to specify, especially when one needs to use node or circuit element names to map the post-layout nodes or circuit elements to the corresponding pre-layout nodes or circuit elements for examination or verification. The problem is exacerbated when the post-layout netlist is not in a “proper” DSPF netlist, uses index nodes or element names, or is a SPICE netlist. Manual matching is practical only when there are only a few nodes required to be selected for examination. When there are more nodes required to be selected or when the whole circuit is required, such an approach is not practical. During circuit verification and debugging, a designer often prefers to select every node in the circuit for examination. To facilitate specifying a large number of nodes, the “wild card matching” method allows a wild card character (e.g., “*”) to be used in a name. For example, the name “*ABC*” is interpreted to mean a selection of all names containing the character string “ABC”. Most circuit simulators support wild card matching. However, wild card matching is not useful when the names are index numbers. Using wild card matching also tends to select for examination far more data than is necessary.

Furthermore, since the post-layout netlist is flat (i.e., not hierarchical), the circuit simulation result database is also flat. Most waveform display tools that operate from such a database typically cannot resolve flattened hierarchical names. Thus, a user may be presented with far too many node names at once to select nodes for display. In that situation, a user often resorts to a filter function in the waveform tool that is able to process the hierarchical names to find the matching nodes. Such a filter function can be very slow when the output database is large. In addition, a hierarchical name may be matched by hundreds of nodes in the database. At that point, the user may have to manually trace in the post-layout netlist to identify the intended node to examine. The entire process from specifying the hierarchical name to successfully reaching the intended node to examine is very time consuming. When the element or node name is an index number, the matching process may be even more difficult. Due to the inefficiency in this process, many hours, even days, may be spent reviewing just one set of circuit simulation results.

The post-layout netlists are often significantly larger than the pre-layout netlist, resulting in a post-layout circuit simulation output database that may be tens or hundreds of times larger than the corresponding pre-layout circuit simulation output database, even when circuit reduction techniques are used. Because a designer may need to access any node within the circuit during the verification and debugging phases, most designers will select all the nodes for output. Post-layout circuit simulation output file sizes are often in the Gigabyte range (i.e., one billion bytes or more). Outputting such large output file in simulation is very slow, the time to output the waveform may be comparable or even longer than the time required for carrying out the circuit simulation itself. Displaying such large file in waveform viewer is also very slow. As a result, designer productivity suffers.

As mentioned above, the efforts to improve post-layout circuit simulation performance have mainly focused on reducing parasitic circuit elements or circuit size. For example, U.S. Patent Application Publication No. 2003/0126575, entitled “RC netlist reduction for timing and noise analysis,” discloses a RC parasitic reduction method to improve circuit analysis speed while maintaining good accuracy. U.S. Pat. No. 6,874,132, entitled “Efficient extractor for post-layout simulation on memories,” discloses a post-layout circuit size reduction method that extracts only the active rows and columns of a memory array. U.S. Patent Application Publication No. 2009/0113356, entitled “Optimization of Post-Layout Arrays of Cells for Accelerated Transistor Level Simulation,” discloses an approach for reducing post-layout array in memory circuits to accelerate transistor level simulation. However, the present inventor is not aware of any solution developed to address inefficiency in usage of post-layout circuit simulation data. Therefore, what is needed is a new method on how to create and access post-layout circuit simulation results for examination. Such a method would reduce output file size—hence storage requirements—significantly, while also improving circuit simulation speed. There is also a need to reduce the number of nodes displayed, without loss of information essential for debugging and verification. The flattened circuit simulation results also need to be converted to a hierarchical format to allow the waveforms in the simulated nodes to be easily accessed and displayed.

### SUMMARY

The present invention provides a method for creating and accessing post-layout circuit simulation results for examination. A method of the present invention reduces output file size—hence storage requirements—significantly, while improving circuit simulation speed. In addition, a method of the present invention reduces the number of nodes displayed, without loss of information essential for debugging and verification. The flattened circuit simulation results are also converted to refer to hierarchical names, so as to allow the waveforms of the simulated nodes to be easily accessed and displayed. Therefore, the present invention significantly improves designer productivity during circuit verification and debugging phases.

According to one embodiment of the present invention, a method identifies subnets that are instance pin nodes and sub-nodes, and identifies whether an instance pin node is a driver node or a receiver node, and provides output statements referring to the identified subnets in post-layout netlist formats, e.g., the proper DSPF format, a simplified DSPF format, or a SPICE netlist format. A path-tracing program may be used to find parasitic circuit elements and subnets, and to identify whether a subnet is an instance pin node or a sub-node and whether an instance pin node is a driver node or a receiver node. The method may be implemented in a circuit simulator, as a pre-processor to a circuit simulator, or a post-processor to a circuit simulator. When implemented in a circuit simulator, the method reduces the number of post-layout nodes to be output, based on user preference. When implemented in a preprocessor to a circuit simulator, the method receives both a pre-layout netlist that includes output commands and a post-layout netlist, and generates output statements to be included in the post-layout netlist, according to user specification. The output statements output a reduced number of nodes than a conventional post-layout circuit simulation would normally output. When implemented in a post-processor to a circuit simulator, the method receives a pre-layout netlist that includes output statements, a post-layout simulation netlist, a circuit simulation result waveform database, and provides, based on user preference, a reduced circuit simulation result waveform database.

According to one embodiment of the present invention, a method addresses how output waveforms are displayed in a waveform display program. The method not only converts a flattened waveform database into a hierarchical waveform database, but also improves readability and intuitiveness of assigned hierarchical node names in a waveform display tool to facilitate navigation and node selection.

According to one embodiment of the present invention, a path-tracing program finds all the nodes within a net and determines whether they are instance pin nodes or sub-nodes. To represent a flattened signal in a hierarchical output database (e.g., a subnet node name that is an index number or device terminal, which may be named differently from its associated net), a method of the present invention uses a SPICE output statement to assign a hierarchical name to the output signal.

The present invention has at least two advantages over conventional post-layout circuit simulations. First, the number of nodes output in a post-layout circuit simulation based on the output statements of the present invention is significantly reduced, so that storage requirements for the post-layout circuit simulation results are in the same order of magnitude as the corresponding pre-layout circuit simulation results. Second, the unfamiliar flattened signal names are renamed as hierarchical names similar to those used in a pre-layout circuit simulation. The output database is also organized hierarchically. Thus, navigating the post-layout circuit simulation results within a waveform tool is thus made much easier and may, in fact, be similar to navigating results of a pre-layout circuit simulation. In addition, essential information is preserved. For example, the signal timings for the leading, trailing edges and the interconnect delays are all preserved. The present invention also reduces the time required to carry out a post-layout circuit simulation.

The present invention is better understood upon consideration of the detailed description below in conjunction with the accompanying drawings.

### BRIEF DESCRIPTION OF THE DRAWINGS

FIG. 1 is a block diagram showing a method in a preprocessor of a circuit simulator for reducing the size of a post-layout circuit simulation output database, according to one embodiment of the present invention;

FIG. 2 is a block diagram showing a method in a post-processor for reducing a post-layout circuit simulation output database, according to one embodiment of the present invention;

FIG. 3A illustrates a SPICE netlist of a 3-inverter circuit;

FIG. 3B shows the schematic of an inverter of the 3-inverter circuit of FIG. 3A;

FIG. 3C illustrates, on the left drawing and the right drawing, respectively, a flattened view and a hierarchical view of the three serially connected inverters of FIG. 3A.

FIG. 3D shows a pre-layout SPICE netlist of a buffer circuit “BUF”;

FIG. 3E shows the schematic of buffer circuit “BUF” of FIG. 3D;

FIG. 4 is a proper post-layout DSPF netlist for buffer circuit “BUF” of FIG. 3E, using flattened hierarchical names;

FIG. 5 is a post-layout DSPF netlist for buffer circuit “BUF” of FIG. 3E, in which index numbers are used for the node names;

FIG. 6A is a post-layout SPICE netlist, in which each net of buffer circuit “BUF” of FIG. 3E is provided in a sub-circuit (.subckt) definition;

FIG. 6B is a post-layout SPICE netlist for the buffer circuit “BUF” in which the post-layout nets are not separately set forth in sub-circuit (.subckt) definitions;

FIG. 7A shows all the subnet voltage waveforms of a simulation of post-layout net INT in the buffer circuit “BUF” of FIG. 3E;

FIG. 7B shows a leading edge of a waveform of a subnet (specifically, instance pin driver node M3:s) in net INT (See, FIG. 9 for subnet locations);

FIG. 7C shows a trailing edge of a waveform of a subnet (specifically, instance pin receiver node M0:g) in net INT (See, FIG. 9 for subnet location);

FIG. 7D shows a waveform envelope for net INT, including the leading edge of a waveform at instance pin driver node M3:s and the trailing edge of a waveform for instance pin receiver nodes M0:g, respectively (See, FIG. 9 for subnet locations);

FIG. 7E shows leading edges of the waveforms for instance pin driver nodes M2:s and M3:s in net INT. (See, FIG. 9 for subnet locations);

FIG. 7F shows trailing edges of the waveforms of instance pin receiver nodes M0:g and M1:g in net INT. (See, FIG. 9 for subnet locations);

FIG. 7G shows a waveform envelope of net INT, including the leading edges of the waveforms at instance pin driver nodes M2:s and M3:s and the trailing edges of the waveforms for instance pin receiver nodes M0:g and M1:g, respectively;

FIG. 8A shows a simulation deck used in a post-layout circuit simulation for buffer circuit “BUF”;

FIG. 8B shows a generated simulation deck for a post-layout circuit simulation of buffer circuit “BUF”, when the user output preference is set to “pin”, according to one embodiment of the present invention;

FIG. 8C shows generated output statements for a post-layout circuit simulation of buffer circuit “BUF”, when the user output preference is set to “driver”, according to one embodiment of the present invention;

FIG. 8D shows generated output statements for a post-layout circuit simulation of buffer circuit “BUF”, when the user output preference is set to a single receiver node, according to one embodiment of the present invention;

FIG. 8E shows the generated output statements for a post-layout circuit simulation of circuit buffer “BUF”, when the user output preference is set to “envelope”, according to one embodiment of the present invention;

FIG. 9 is a schematic circuit of post-layout buffer circuit “BUF”, which illustrates using a path-tracing program to identify subnets of post-layout nets, according to one embodiment of the present invention; and

FIG. 10 is a schematic circuit of post-layout buffer circuit “BUF”, which illustrates node-matching using element names to identify subnets of post-layout nets, according to one embodiment of the present invention.

### DETAILED DESCRIPTION

Reference is now made in detail to one or more embodiments of the present invention. While the present invention is described in conjunction with these embodiments, such embodiments are not intended to be limiting the present invention. On the contrary, the present invention is intended to cover alternatives, variations, modifications and equivalents within the scope of the present invention, as defined in the accompanying claims.

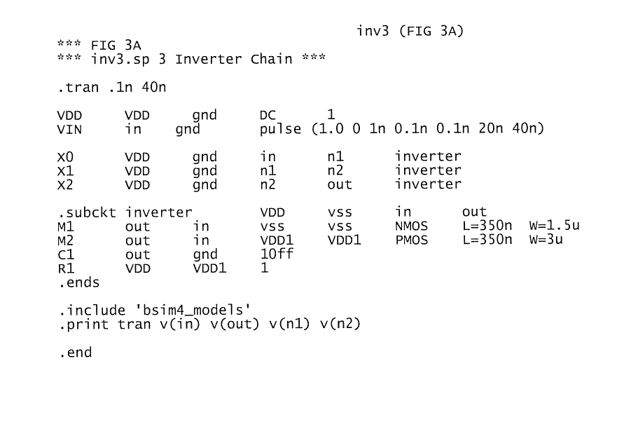

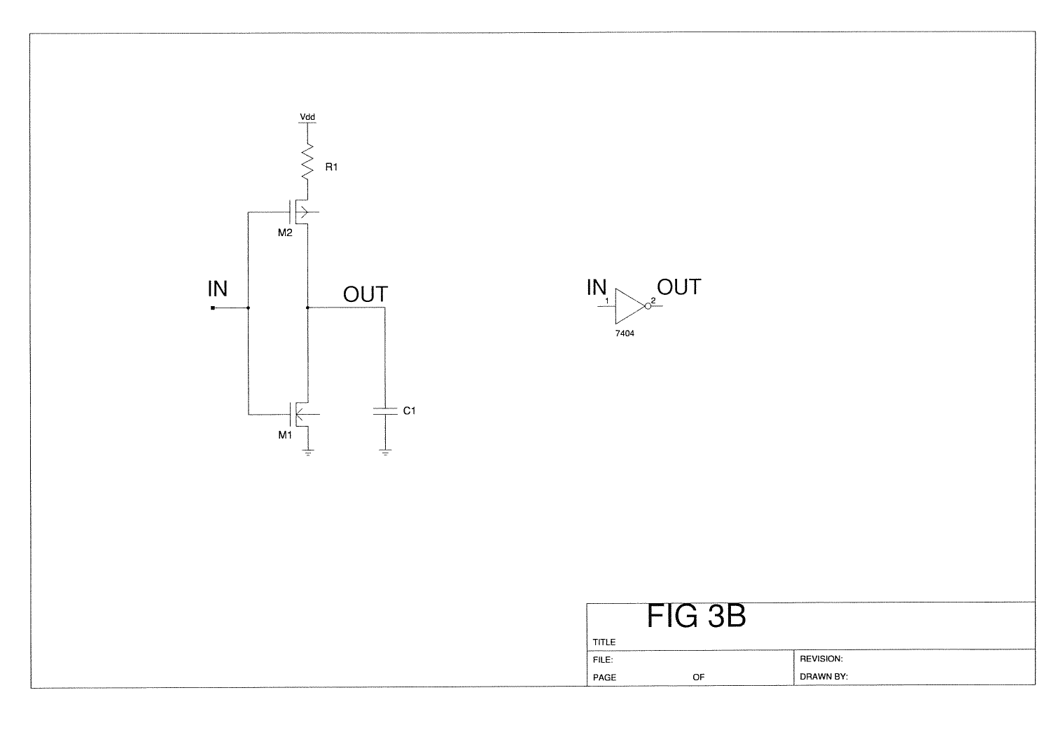

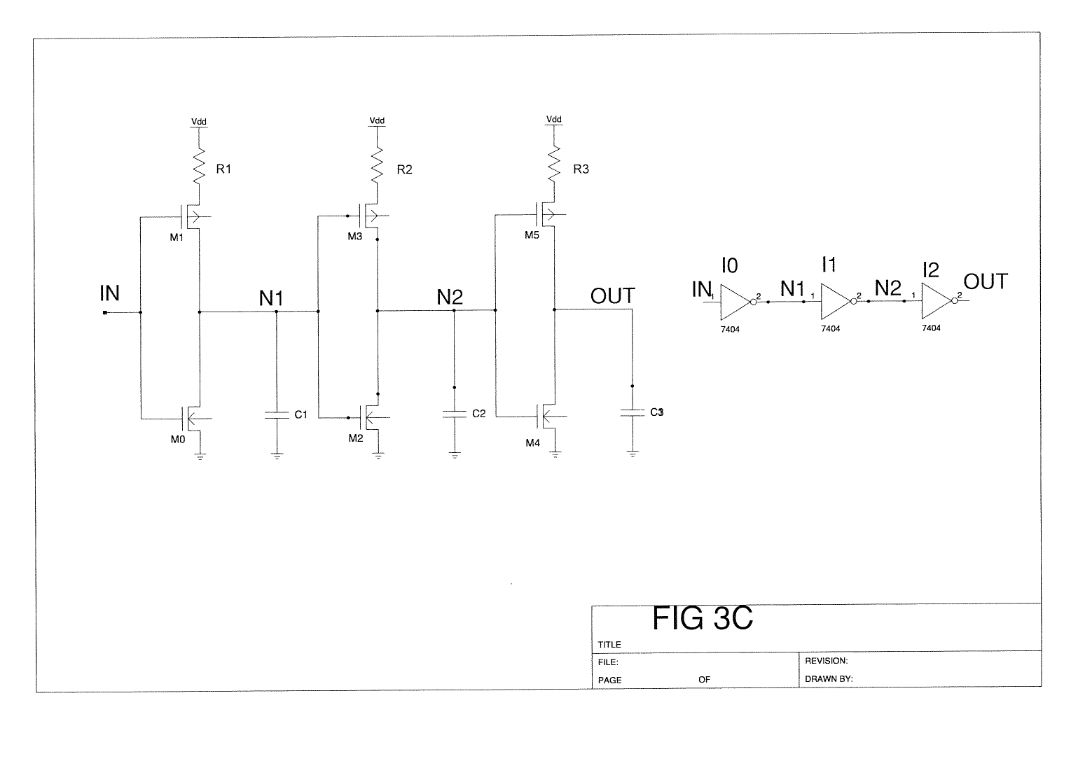

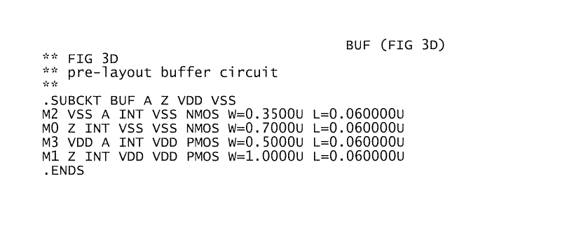

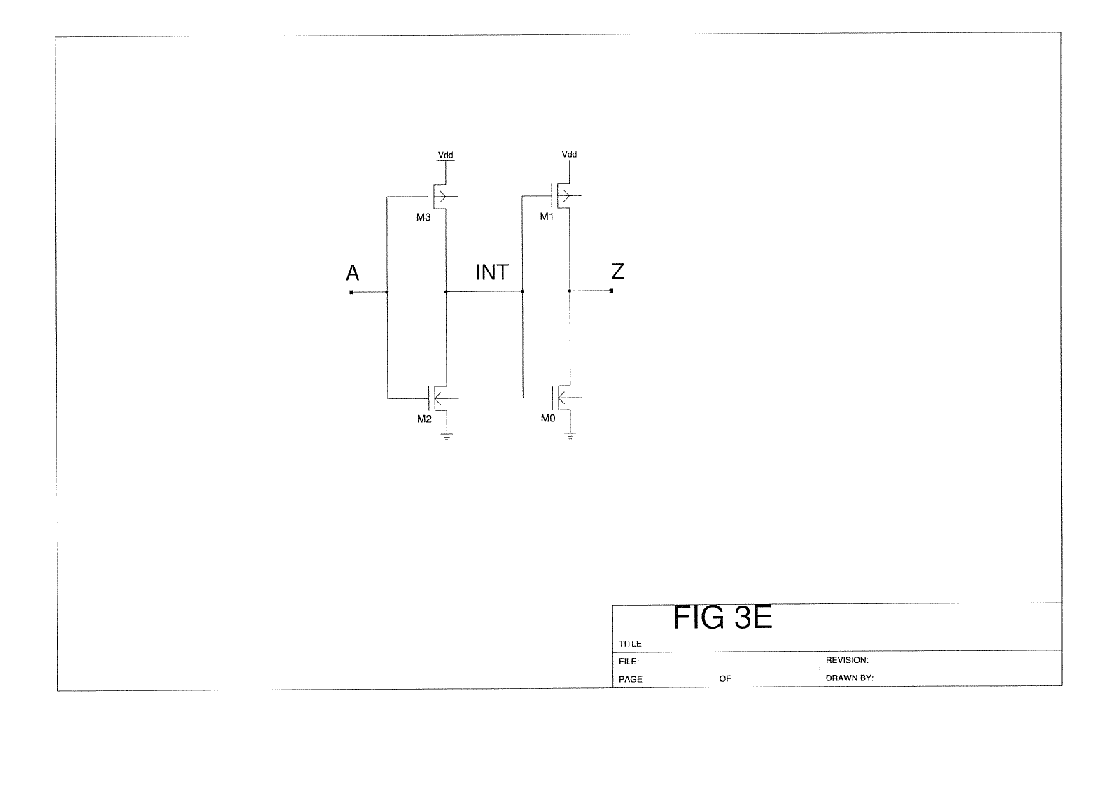

Hierarchical and flattened pre-layout and post-layout circuit descriptions or netlists are illustrated by way of examples in FIGS. 3A-3E, FIGS. 4-5, and FIGS. 6A-6B.

FIG. 3A shows a typical SPICE-compatible netlist of a 3-inverter circuit. The netlist describes a circuit that includes MOS transistors, resistors, and capacitors; the netlist contains a sub-circuit definition of an inverter provided in the .subckt directive, and serially connected instances X0, X1 and X2 of the inverter sub-circuit, each of which contains two MOS transistors, a resistor and a capacitor. As shown in FIG. 3A, in the sub-circuit definition, an inverter cell is defined which includes four ports—“VDD”, “vss”, “in” and “out”. The inverter sub-circuit is shown schematically in FIG. 3B, including NMOS transistor M1, PMOS transistor M2, resistor R1, and capacitor C1. The top level circuit description in the netlist of FIG. 3A also defines VDD and VIN as supply and input voltage sources, respectively. The right drawing of FIG. 3C illustrates schematically the serially connected inverters of FIG. 3A. As each inverter instance is represented by an inverter symbol, rather than the basic circuit elements (e.g., transistors, resistors, and capacitors), the view illustrated in the right drawing of FIG. 3C is considered “hierarchical.” The netlist also includes a reference to another file “bsim4_models” which contains the device models for the NMOS and PMOS transistors. The netlist also includes “.print” output statements which output the voltages of nodes “in”, “out”, “n1” and “n2”.

The left drawing of FIG. 3C illustrates, respectively, a flattened view of the three serially connected inverters of FIG. 3A. The flattened view shows that, when the circuit elements of instances X0, X1 and X2 are drawn with express details, the circuit of FIG. 3A has six MOS transistors (M0, M1, M2, M3, M4, M5), three resistors (R1, R2, R3), and three capacitors (C1, C2, C3).

FIG. 3D shows a pre-layout SPICE netlist for buffer circuit “BUF”. As shown in FIG. 3D, the netlist for buffer circuit “BUF” includes four MOS transistors—M0, M1, M2 and M3, and four ports—A, Z, VSS and VDD. FIG. 3E shows schematically buffer circuit “BUF” of FIG. 3D.

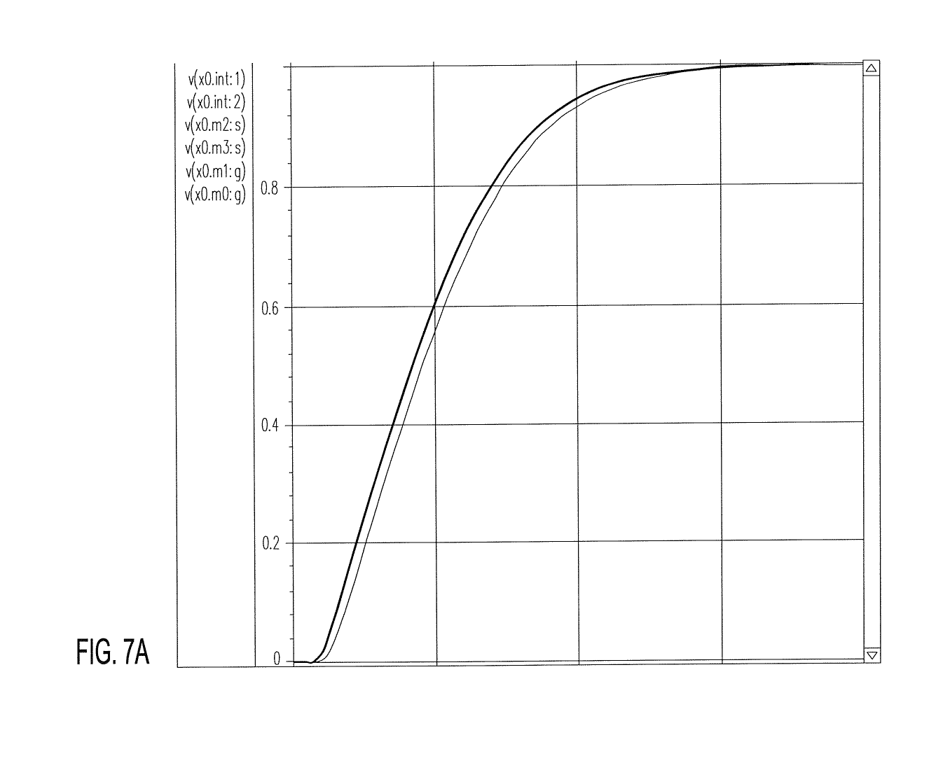

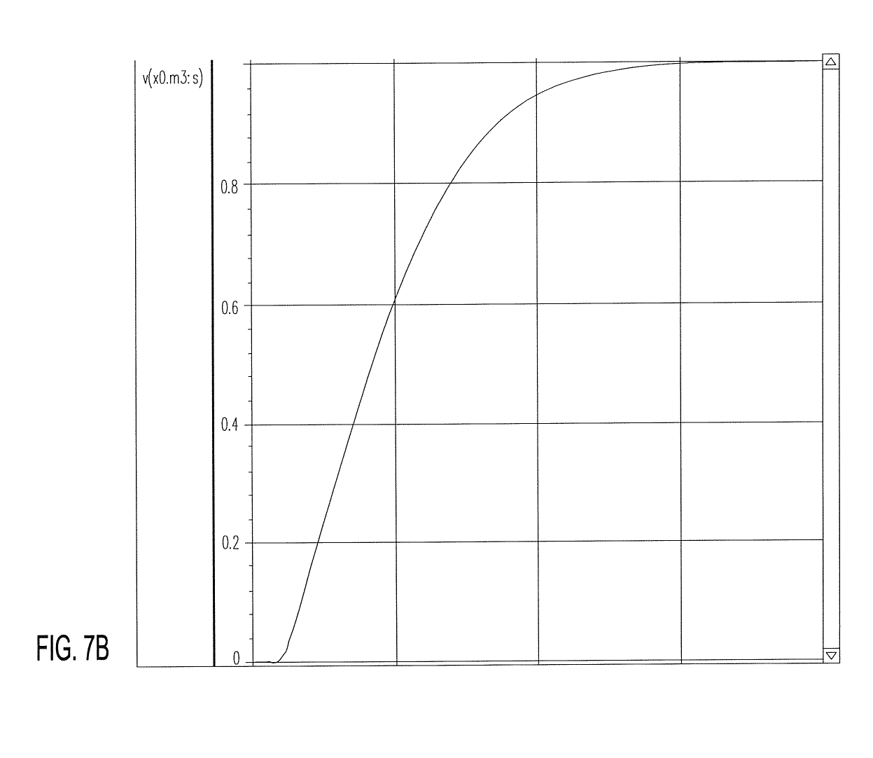

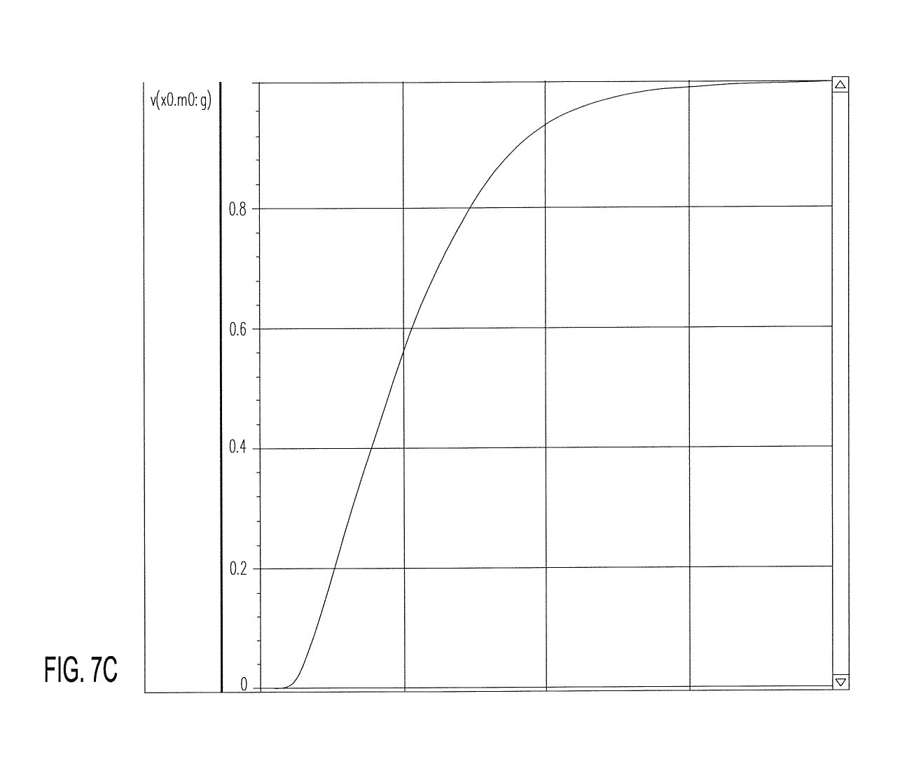

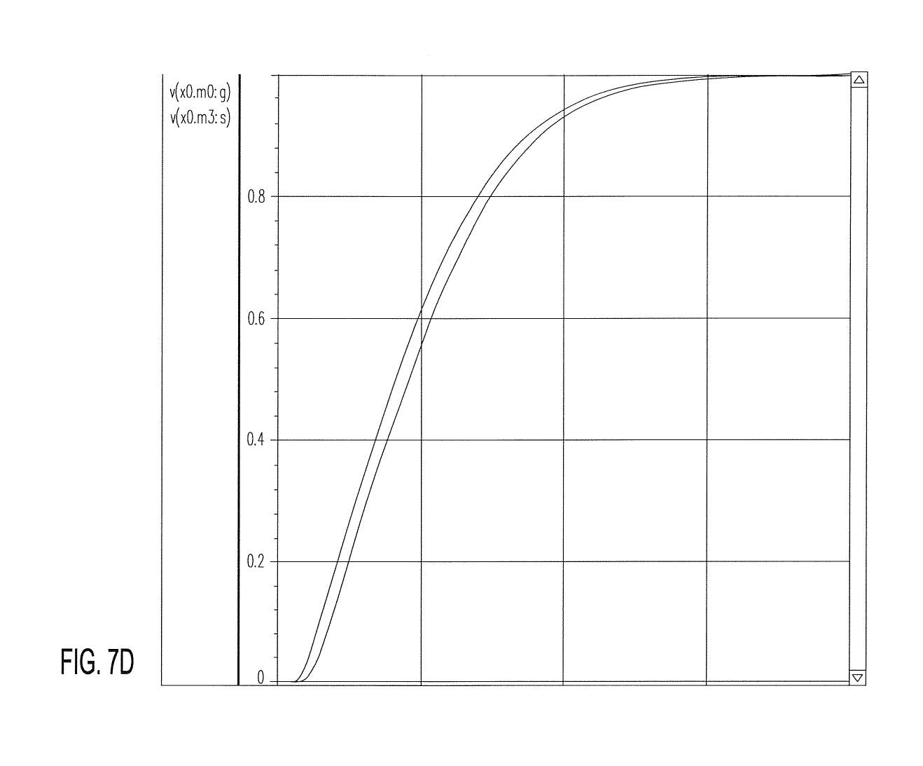

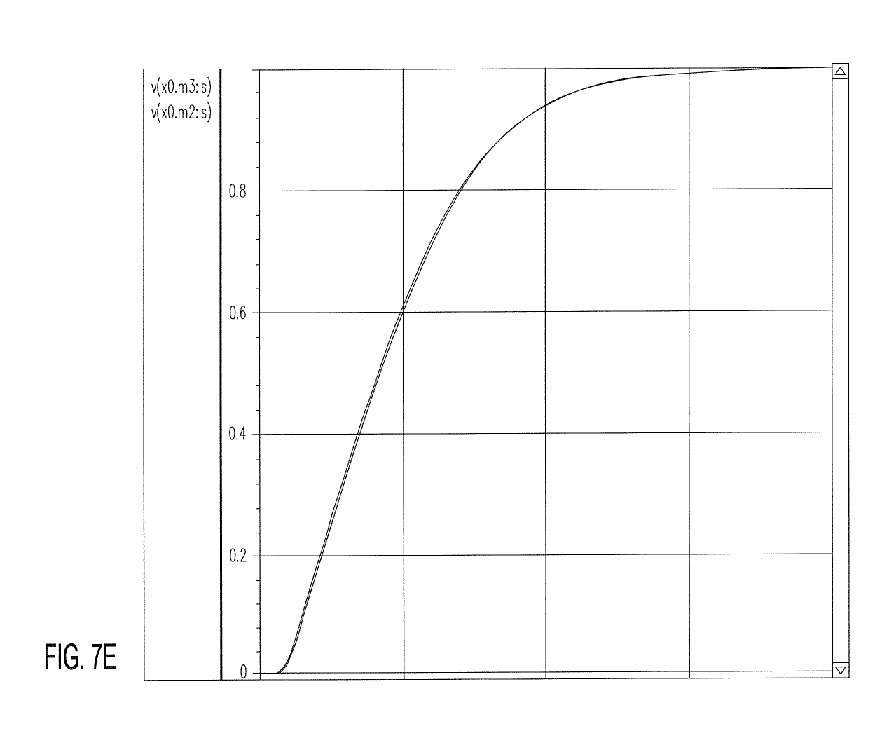

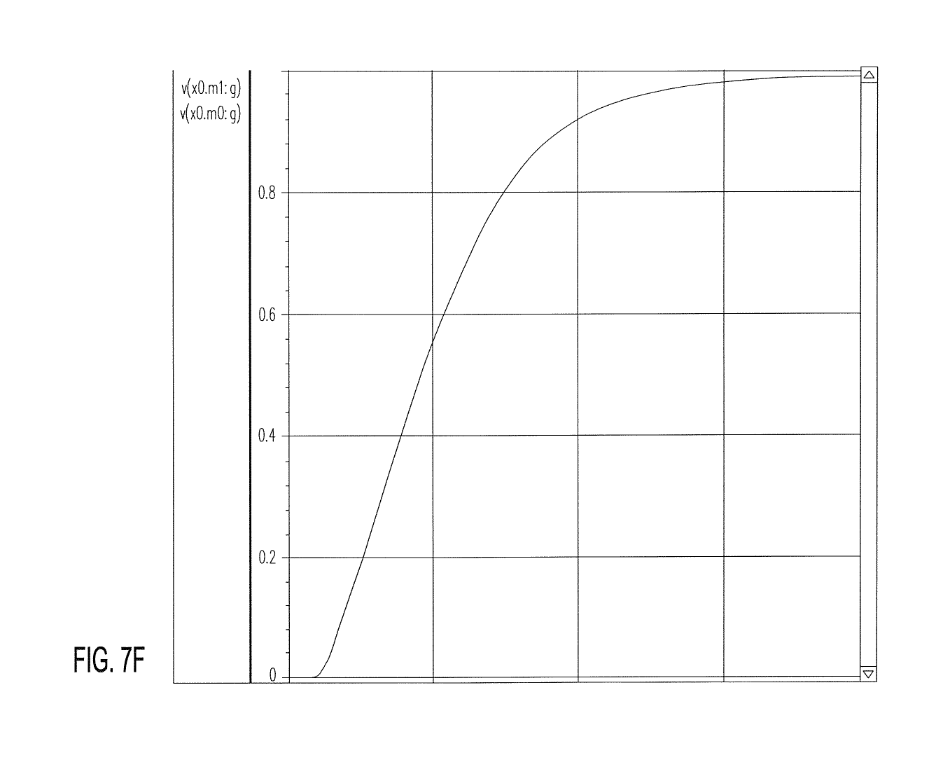

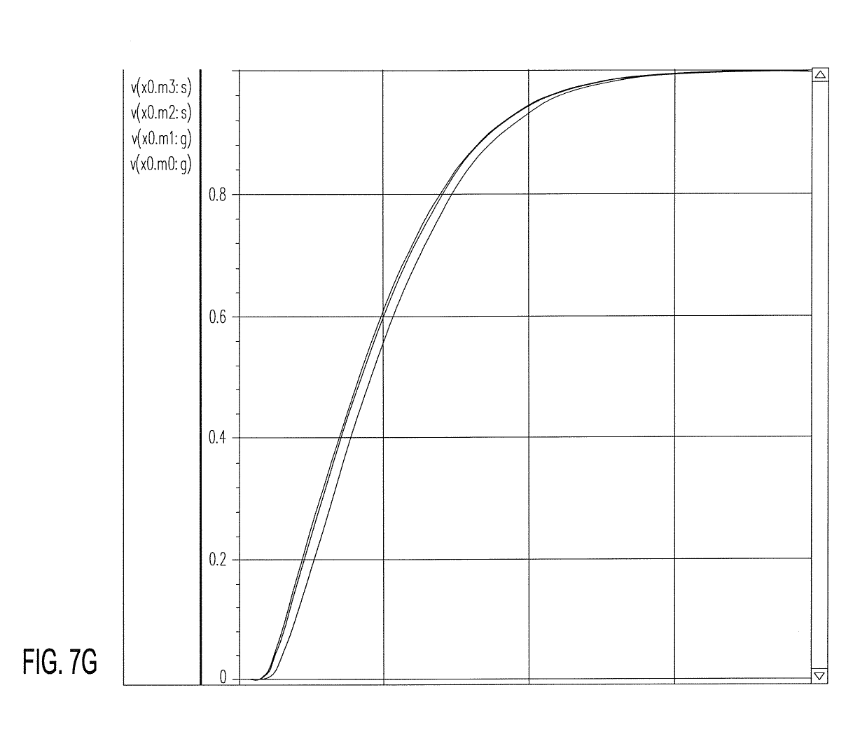

A post-layout netlist includes both the circuit elements of the pre-layout netlist and parasitic resistor and capacitor elements. This is best illustrated by a DSPF format netlist, which lists in a “net section” the parasitic circuit elements associated with nets. A net in a post-layout DSPF netlist typically includes parasitic circuit elements and subnets. Subnets may be further divided into nodes that are pins, instance pins and sub-nodes. A subnet that is a pin represents a pin that is connected to the pre-layout net. A pin with a PinType of “IN” is considered a driver node to the net. A subnet that is an instance pin represents a pin of a pre-layout circuit element connected to the pre-layout net. Some instance pins are driver nodes, while other instance pins are receiver nodes. For example, an instance pin connected to a drain or source terminal of a MOSFET is a driver node, while an instance pin connected to a gate terminal of a MOS is a receiver node. (Drain and source terminals of a MOSFET are typically interchangeable.) A subnet that is a sub-node is not connected to either a pre-layout net or a pre-layout circuit element. The subnets in a DSPF netlist are treated as discrete nodes in a circuit simulation. Typically in a post-layout circuit simulation, node voltages are output for all nodes or for nodes that are specified using pattern-matching. Thus, when a net is selected for output, most or all of its subnets are selected for output. However, as shown in FIG. 7A, the voltage waveforms of the subnets in a post-layout net closely resemble each other, such that the waveforms can be enclosed by a single envelope. Furthermore, as shown in FIG. 7D, for each net, the waveforms of internal sub-nodes in the subnets can also be enclosed by the waveforms for the pins and instance pins.

Ideally, a fully compliant DSPF netlist (in a “proper” DSPF netlist format) provides all information required to determine whether a subnet is a pin, an instance pin or a sub-node. However, not all DSPF netlists provide complete information. To reduce file size, some simplified DSPF netlists may only provide NET information, which specifies only the post-layout net without specifying the subnets. Also, a post-layout SPICE netlist does not follow the net-by-net format of a DSPF netlist, as circuit elements and nodes are randomly arranged. Some post-layout SPICE netlists group all the subnets of a net together in a subcircuit (“.subckt”) definition, so that every net has a subcircuit which defines the post-layout subnets.

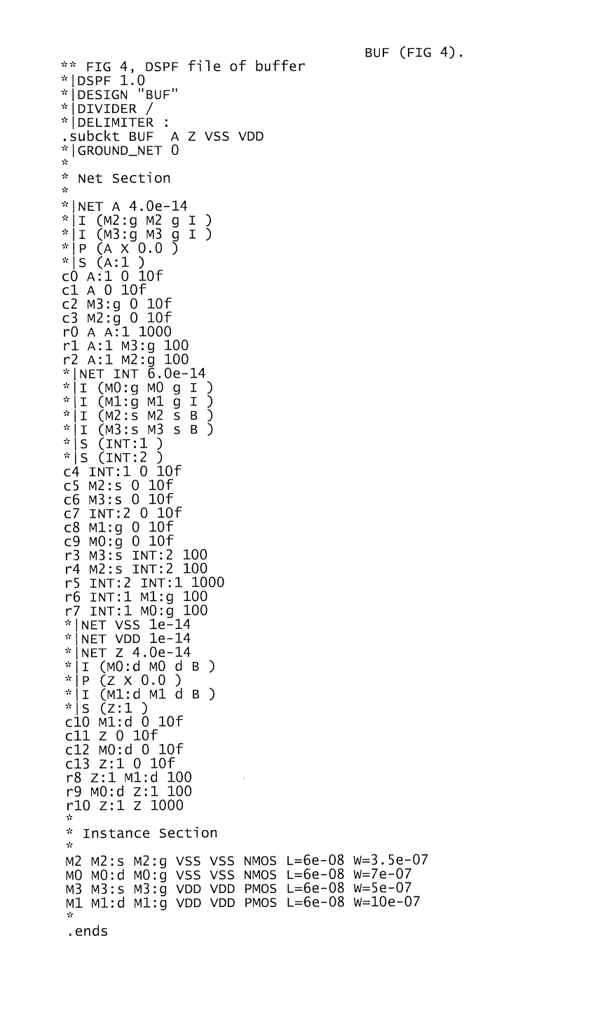

FIG. 4 is a proper post-layout DSPF netlist for buffer circuit “BUF” of FIG. 3E, using flattened hierarchical names. As shown in FIG. 4, the netlist includes nets listed in a “Net Section.” Information regarding the subnets within each net is provided following the |NET directive: pin (the |P directive), instance pin (the |I directive) and sub-node (the |S directive). This information allows the net to be directly mapped to one or more pre-layout nodes, and facilitates user selection of pins or instance pins (which may be driver nodes or receiver nodes) or sub-nodes for output. The waveforms associated with these nodes are often displayed to allow examination of leading edges, trailing edges, or envelopes of signals in circuit simulation results or waveforms. In FIG. 4, the node names used are flattened hierarchical names. For example, net INT includes:

*|NET INT 6e-14

### *|I(M0:g M0 g I)

### *|I(M1:g M1 g I)

### *|I(M2:s M2 s B)

### *|I(M3:s M3 s B)

*|S(INT:1)
*|S(INT:2)

Therefore, subnets M0:g, M1:g, M2:s, M3:s are identified as instance pins that connect to the gate terminals of MOS transistors M0 and M1, and source terminals of MOS transistors M2 and M3, respectively. Subnets INT:1 and INT:2 are identified as sub-nodes that are neither connected to pins nor instance pins. No subnet that is identified as a pin is listed for net INT. (In contrast, a pin is listed as a subnet in each of nets A and Z.)

Parasitic circuit elements within a net are then listed after the pin, instance pin and sub-node specifications for the net. In FIG. 4, parasitic resistors r0-r10, parasitic capacitors c0-c13 and their nodes are listed for nets A, INT, VSS, VDD and Z (no parasitic resistors or capacitors are specifically listed for nets VSS and VDD). For example, the post-layout parasitic circuit elements of net INT are:

c4 INT:1 0 10f
c5 M2:s 0 10f
c6 M3:s 0 10f
c7 INT:2 0 10f
c8 M1:g 0 10f
c9 M0:g 0 10f
r3 M3:s INT:2 100
r4 M2:s 1NT:2 100
r5 INT:2 INT:1 1000
r6 INT:1 M1:g 100
r7 INT:1 M0:g 100

Parasitic capacitors c4-c9 are subnet-to-ground capacitors for the subnet INT:1, INT:2, M2:s, M3:s, M0:g, and M1:g. Parasitic resistors r4-r7 connect all the subnets within net INT.

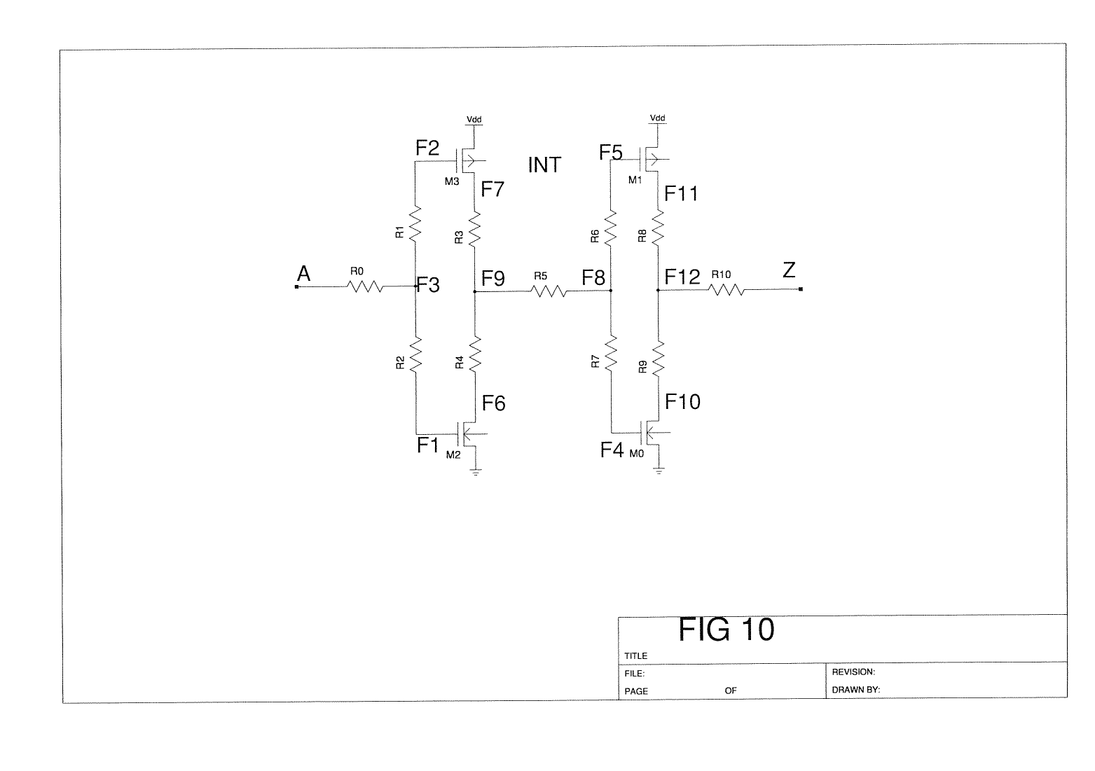

The netlist of FIG. 4 also includes an “Instance Section” in which the pre-layout circuit elements M0, M1, M2 and M3 are listed in its flattened form. The post-layout circuit of FIG. 4 is shown schematically in FIG. 9.

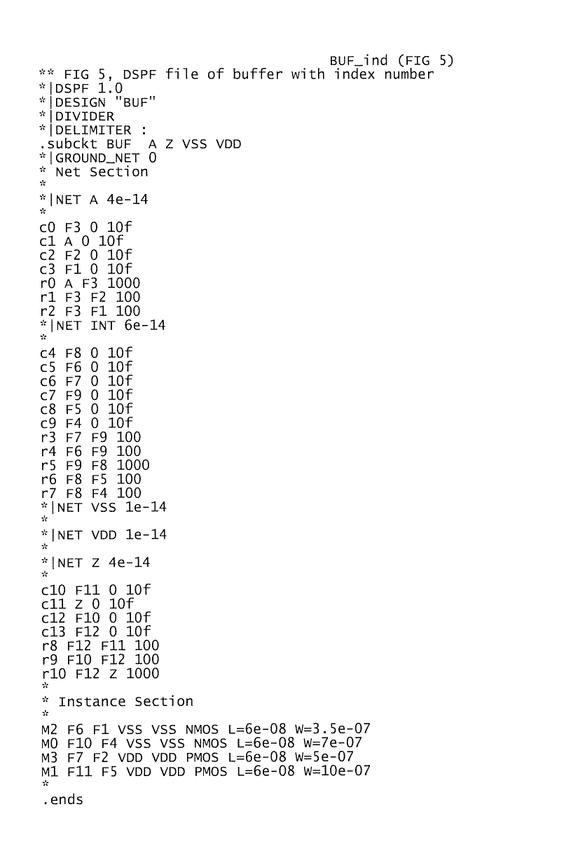

FIG. 5 is a post-layout DSPF netlist for buffer circuit “BUF” of FIG. 3E, in which index numbers are used as node names. As in FIG. 4, the netlist includes a “Net Section” which lists parasitic resistors and capacitors for each of nets A, INT, VSS, VDD, Z. The netlist also includes an “Instance Section” in which pre-layout circuit elements M0, M1, M2 and M3 are listed. In FIG. 5, the node names used are index numbers, and the element names in the Instance Section match the pre-layout names. In contrast to the DSPF netlist of FIG. 4, in the DSPF netlist of FIG. 5, no identification of a subnet as a pin, an instance pin, or a sub-node is provided. Thus, the present invention uses a path-tracing program to determine whether each subnet is a pin, an instance pin, or a sub-node. In the case of an instance pin, the path-tracing program also identifies if the instance pin is a driver node or a receiver node. The post-layout buffer circuit “BUF” of FIG. 5 is shown schematically in FIG. 10.

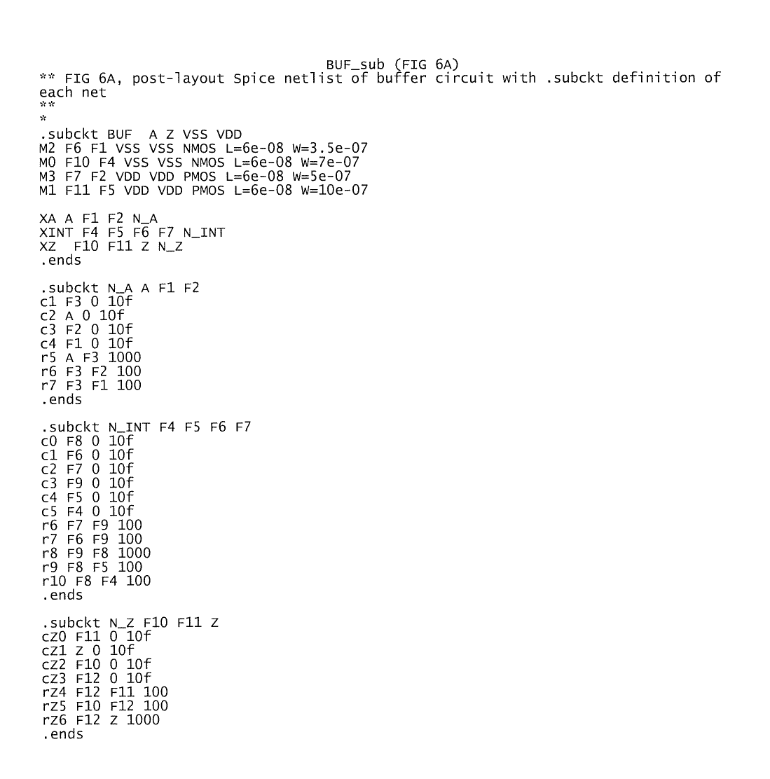

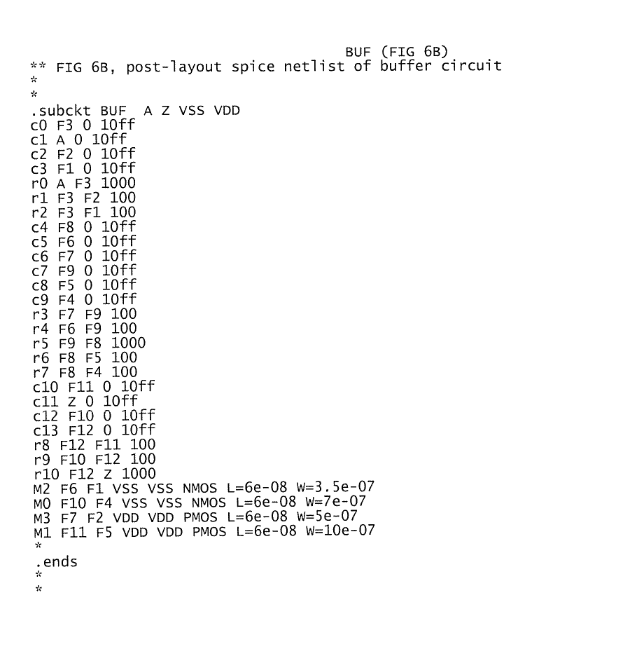

FIG. 6A is a post-layout SPICE netlist, in which each net of buffer circuit “BUF” of FIG. 3E is provided in a subcircuit (.subckt) definition. This format is similar to the DSPF net-by-net approach illustrated in FIG. 5. As shown in FIG. 6A, each subcircuit definition for a net includes both the subnet post-layout circuit elements and its nodes. The name of each subcircuit definition matches a pre-layout node name to facilitate cross-reference. For example, the subcircuits N_A, N_INT and N_Z correspond to pre-layout nets A, INT and Z, respectively, although this netlist format is not a recognized post-layout SPICE netlist. If the subcircuit names cannot be matched to pre-layout node names, a path-tracing program may be used to match element names and connectivity to resolve the pre-layout and post-layout node names, as element names are typically preserved between pre-layout and post-layout circuit netlists. In addition, the path-tracing program may also identify if a node is a pin, an instance pin driver node, an instance pin receiver node, or a sub-node.

FIG. 6B is a post-layout SPICE netlist for buffer circuit “BUF” in which the post-layout nets are not separately set forth in subcircuit (.subckt) definitions. A path-tracing program may be used to identify the post-layout parasitic circuit elements and nodes within each net and to determine whether a subnet is a pin, an instance pin driver node, an instance pin receiver node, or a sub-node. The path-tracing program may perform this determination by matching element names and connectivity, as pre-layout element names are preserved between pre-layout and post-layout netlists.

The present invention exploits certain characteristics of the post-layout waveforms that allow a significant reduction in the size of the output database, as well as improving the time required for carrying out a post-layout circuit simulation. FIG. 7A shows all the subnet voltage waveforms of a simulation of post-layout net INT in buffer circuit “BUF” of FIG. 3E. The waveforms of FIG. 7A include waveforms of all subnets of net INT, including all driver nodes, receiver nodes and sub-nodes. FIG. 7A confirms that the voltage waveforms of all subnets within a post-layout net, such as INT, are similar. Each waveform differs from another due to their respective timing delays within the post-layout net.

FIG. 7B shows a leading edge of a waveform of a subnet (specifically, instance pin driver node M3:s) in net INT. (See, FIG. 9 for subnet location).

FIG. 7C shows a trailing edge of a waveform of a subnet (specifically, instance pin receiver node M0:g) in net INT. (See, FIG. 9 for subnet location).

FIG. 7D shows a waveform envelope of net INT, including the leading edge of a waveform at instance pin driver node M3:s and the trailing edge of a waveform for instance pin receiver nodes M0:g, respectively.

FIG. 7E shows leading edges of the waveforms for instance pin driver nodes M2:s and M3:s in net INT. (See, FIG. 9 for subnet locations).

FIG. 7F shows trailing edges of the waveforms of instance pin receiver nodes M0:g and M1:g in net INT. (See, FIG. 9 for subnet locations).

FIG. 7G shows a waveform envelope of net INT, including the leading edges of the waveforms at instance pin driver nodes M2:s and M3:s and the trailing edges of the waveforms for instance pin receiver nodes M0:g and M1:g, respectively.

From these figures, it is observed that:
1. Approximate timing in the waveforms of a net may be obtained from the waveforms of any sub-node, pin or instance pin in the net.
2. The leading edges in the waveforms of a net may be obtained from the waveforms of a subnet of a driver node in the net (e.g., an input pin node or an instance pin node connected to a drain or source terminal of a MOSFET).
3. The trailing edges in the waveforms of a net may be obtained from the waveforms of an output pin or subnet that is a receiver node of the net (e.g., an instance pin node connected to a gate terminal of a MOSFET). When there is no receiver node in the net, then a driver node of the net can be used.
4. The leading and trailing edges or the envelope of the waveforms of a net may be obtained from the waveforms of a pin or an instance pin of the net, or from the waveforms of a driver node and a receiver node of the net.

A user may select any suitable waveform from among the driver nodes, the receiver nodes, or the envelopes of a net.

According to one embodiment of the present invention, a method identifies subnets that are instance pins and sub-nodes, identifies whether an instance pin is a driver node or a receiver node, and generates output statements in post-layout netlist formats, e.g., the proper DSPF format, a simplified DSPF format, or a SPICE netlist format. A path-tracing program may be used to find parasitic circuit elements and subnets and identifies whether a subnet is an instance pin or a sub-node and whether an instance pin is a driver node or a receiver node. The method may be implemented in a circuit simulator, as a pre-processor to a circuit simulator, or a post-processor to a circuit simulator. When implemented in a circuit simulator, the method reduces the number of post-layout nodes to be output, based on user specification. When implemented in a preprocessor to a circuit simulator, the method receives both a pre-layout netlist that includes output statements and a post-layout netlist, and generates output statements for inclusion in the post-layout netlist, according to user specification. Typically, the generated output statements output a reduced number of nodes. When implemented in a post-processor to a circuit simulator, the method receives a pre-layout netlist that includes output statements, a post-layout simulation netlist, and a post-layout simulation result output waveform database, and provides, based on user specification, a reduced simulation result output waveform database.

According to one embodiment of the present invention, a method addresses how output waveforms are displayed in a waveform display program. The method not only converts a flattened waveform database into a waveform database accessible by hierarchical names, but also improves readability and intuitiveness of assigned hierarchical node names in a waveform display tool to facilitate navigation and node selection.

In the proper DSPF netlist format, the “DIVIDER” and “DELIMITER” directives support hierarchy. The header of a DSPF file may contain the following statements:

### *DSPF 1.0

### *DIVIDER /

### *DELIMITER:

### *BUS_DELIMITER [ ]

The DIVIDER directive defines a character to be used for separating instant names in a hierarchical name and the DELIMITER directive defines a character to be used for introducing a subnet node name. For example, the hierarchical node names may be:

### /X1/X2/A:3

### /I1/12/A:3

### /XI1/XI2/A:3

In the first example, /X1/X2/A:3 specifies a node in subnet A:3 of net A in instance X2, which is within instance X1. The two other examples illustrate that different layout parasitic extractor programs may use slightly different naming convention for hierarchical node names. In these examples, X1, I1, and XI1 are names generated under different naming conventions for the same instance. Once the hierarchy of a node name is identified, the name can be used in a hierarchical database accordingly.

An instance pin presents a different issue. An instance pin in net /X1/X2/A may be named /X1/X2/X3/M1:d. Although this node is an instance pin within net /X1/X2/A, by observing the names alone, there is no clear connection between the two names, /X1/X2/A and /X1/X2/X3/M1:d. In the proper DSPF netlist format, the node /X1/X2/X3/M1:d is identified as an instance pin within net /X1/X2/A in the net section as shown by:

### *|NET /X1/X2/A

. . .

### *|I(/X1/X2/X3/M1:d /X1/X2/X3/M1 . . . )

However, if the netlist is not presented in a proper DSPF netlist or as a SPICE netlist, the information connecting the names /X1/X2/A and /X1/X2/X3/M1:d is not available. The path-tracing program of the present invention finds all the nodes within each net and determines whether they are instance pins or sub-nodes. To represent a flattened signal in a hierarchical output database (e.g., a subnet node name that is an index number or a device terminal, which may be named differently from its associated net), a method of the present invention uses a SPICE output statement to assign a hierarchical name to the signal to be output. (This output statement may be used with practically all commercial circuit simulation programs.) For example, a pre-layout simulation may have the output statement:

.print tran v(X1.X2.A) v(X2.X3.B) i(X1.X2.M1)

The symbol “.” in the net name is the default hierarchy divider used by most circuit simulators. The following output statements using corresponding hierarchical names may be generated for a post-layout simulation of the circuit:

.print tran X1.X2.A=v(/X1/X2/A)
.print tran X1.X2.A:DDD:1=v(/X1/X2/X3/M1:d)
.print tran X1.X2.A:RRR:1=v(/X1/X2/X4/M2:g)
.print tran X1.X2.A:SSS:1=v(/X1/X2/A:3)
.print tran X2.X3.B:RRR:1=v(F1234)
.print tran X1.X2.M1:III:1=i(/X1/X2/M1)

The name “DDD” is a predefined postfix for a driver node; the name “RRR” is a predefined postfix for a receiver node; the name “SSS” is a predefined postfix for a sub-node, and the name “III” is a predefined postfix for node current. A designer may choose to output either a pin, a driver node, a receiver node or a sub-node.

The statement “.print tran X1.X2.A=v(/X1/X2/A)” outputs the voltage of a hierarchical node “X1.X2.A” which corresponds to the net name “/X1/X2/A” in the DSPF netlist format. In this instance, the subnet /X1/X2/A is identified as a pin of net /X1/X2/A. By this statement, the voltage v(/X1/X2/A) is to be output and represented as “X1.X2.A”. The name “X1.X2.A” is a hierarchical name which can be stored in the hierarchical output database.

The statement “.print tran X1.X2.A:DDD:1=v(/X1/X2/X3/M1:d)” outputs a voltage of a driver node of net X1.X2.A where the subnet /X1/X2/X3/M1:d is identified as a driver node. X1.X2.A:DDD:1 is interpreted to refer to the first driver node of hierarchical node X1.X2.A. Similarly, the statement “.print tran X1.X2.A:RRR:1=v(/X1/X2/X4/M2:g)” outputs a receiver node of net X1.X2.A, where the subnet /X1/X2/X4/M2:g is identified as a receiver node. X1.X2.A:RRR:1 is interpreted to refer to the first receiver node of hierarchical node X1.X2.A.

The statement “.print tran X1.X2.A:SSS:1=v(/X1/X2/A:3)” outputs a voltage of a sub-node of net X1.X2.A, where the subnet /X1/X2/A:3 is identified as a sub-node. X1.X2.A:SSS:1 is interpreted to refer to the first sub-node of hierarchical node X1.X2.A.

The statement “.print tran X2.X3.B:RRR:1=v(F1234)” outputs a voltage of a subnet which has index number F1234 as its name. This statement associates index number F1234 to the hierarchical name X2.X3.B, and allows the subnets belonging to net X2.X3.B to be identified. When a designer desires to output a receiver node, from this association, the path-tracing program would identify subnet F1234 as a receiver node of net X2.X3.B. X2.X3.B:RRR:1 is interpreted to refer to the first receiver node of net X2.X3.B.

The statement “.print tran X1.X2.M1:III:1=WX1/X2/M1)” outputs a current through node X1.X2.M1 (or node /X1/X2/M1, hierarchically). X1.X2.M1:III:1 is interpreted to refer to the first current output of hierarchical element X1.X2.M1.

The same technique may be used in other output statements than “.print” (e.g., “.plot”, “.probe”, “.measure”, and others). The “.measure” or “.meas” statement outputs a waveform measurement between signals. Conventionally, a designer painstakingly identifies an exact node name in the post-layout netlist to specify in the “.measure” statement, as an exact name, rather than a name-matching wild card, must be used. The path-tracing program avoids the tedious search of an exact name. For example, consider the following pre-layout statement and its corresponding post-layout statement:

.meas delay_AB . . . v(x1.A) . . . v(x1.B) . . .
.meas delay_AB . . . v(/x1/x2/m1:d) . . . v(/x1/x3/m2:d) . . .

The pre-layout statement measures a delay between signals x1.A and x1.B. The corresponding post-layout statement also measures that delay, but the designer has to specify using exact subnet signal names /x1/x2/m1:d and /x1/x3/m2:d.

According to one embodiment of the invention, the path-tracing program identifies the required signal names from a post-layout netlist and associates them with the pre-layout nets X1.A and X1.B. The .meas statement may then use the identified subnet names in the .meas statements. The following output statement is therefore generated:

.meas delay_AB . . . v(/x1/x2/m2:d) . . . v(/x1/x3/m1:d) . . .

The subnet nodes /x1/x2/m2:d and /x1/x3/m1:d selected by the path-tracing program may be different from what the designer may manually choose. In practice, however, the choice discrepancy is not significant, as the difference in delay between the manually selected nodes and the path-tracing program selection is typically insignificant. Also, a designer often picks nodes randomly, without any apparent preference for the driver nodes, the receiver nodes, or any other subnets. If the post-layout netlist is a proper DSPF netlist, the path-tracing program may identify the post-layout subnets from the net section. If the post-layout netlist is a SPICE netlist, the net-by-net format of the DSPF file format would not be available. In that case, a post-layout net name for each group of subnets is required and may be obtained by either node name matching with pre-layout names, or element name matching with pre-layout names. In either case, the post-layout SPICE netlist needs to contain pre-layout name information in a particular format. Most layout parasitic extraction programs preserve pre-layout net name information in the post-layout SPICE netlists, if requested. The pre-layout node name may directly appear in the post-layout netlist, or be embedded in the post-layout net names as a prefix or a postfix, or the pre-layout name may appear with a different hierarchy divider. For example, the pre-layout net name X1.X2.N3 may be used to provide post-layout net names such as X1_X2_N3 and ABC_X1_X2_N3_21_DEF. In this case of X1_X2_N3, the post-layout name uses a different hierarchy divider from the pre-layout name. In the case of ABC_X1_X2_N3_21_DEF, prefix ABC and postfix DEF are used to generate the post-layout net name, together with character string “21”, which is the subnet index.

Since different parasitic extraction programs use different prefixes, postfixes and hierarchy dividers, element name matching may be more reliable than node name matching for identifying post-layout net names. Typically, element names are exactly matched between a pre-layout netlist and its corresponding post-layout netlist, although different hierarchy dividers, or device finger designations under simple device naming rules are possible. For example, consider the pre-layout element name X1.X2.M1 and the matching post-layout elements MX1/X2/M1 and MX1/X2/M1@1. Under the SPICE naming convention, a MOSFET is assigned a name that has “M” as the first letter. MX1/X2/M1, using a different hierarchy divider “/”, maps to the same element X1.X2.M1. In MX1/X2/M1@1, the “@1” portion represents a device finger in the device X1.X2.M1. (A large transistor may be realized in the layout as a large number of device fingers, each device finger being a separate transistor that may be extracted separately in the post-layout netlist.) Once a device or circuit element is matched between the pre-layout and post-layout netlists, net matching between the pre-layout and post-layout netlists can be performed through tracing the associated nets.

The user can also choose to output waveform envelopes from a net which includes driver and receiver nodes. Although outputting one driver node and one receiver node is the default option, post-layout circuit simulation may also output more driver and receiver nodes. If there is no receiver node in a net, then a driver node may also be considered a receiver node. The waveform envelope, including the leading and trailing edges and the interconnect wire delays, typically contains all the information necessary for circuit analysis. By outputting either just one subnet or the waveform envelope of a net, the number of nodes to be output is significantly reduced. For example, the following statements output just one driver node and one receiver node of net X1.X2.A:

.print tran X1.X2.A:DDD:1=v(/X1/X2/X3/M1:d)
.print tran X1.X2.A:RRR:1=v(/X1/X2/X4/M2:g)

In contrast, the following example outputs all driver and receiver nodes of net X1.X2.A, which includes 2 driver and 2 receiver nodes:

.print tran X1.X2.A:DDD:1=v(/X1/X2/X3/M1:d)
.print tran X1.X2.A:DDD:2=v(/X1/X2/X3/M2:d)
.print tran X1.X2.A:RRR:1=v(/X1/X2/X4/M2:g)
.print tran X1.X2.A:RRR:2=v(/X1/X2/X4/M1:g)

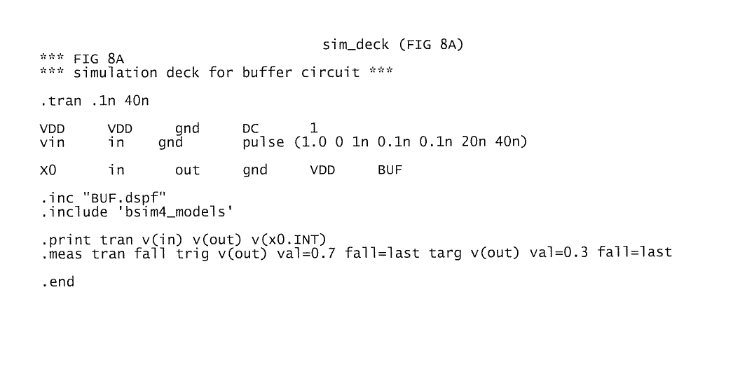

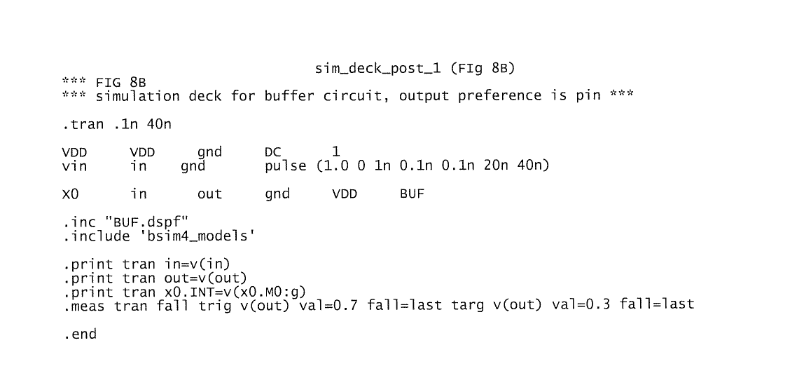

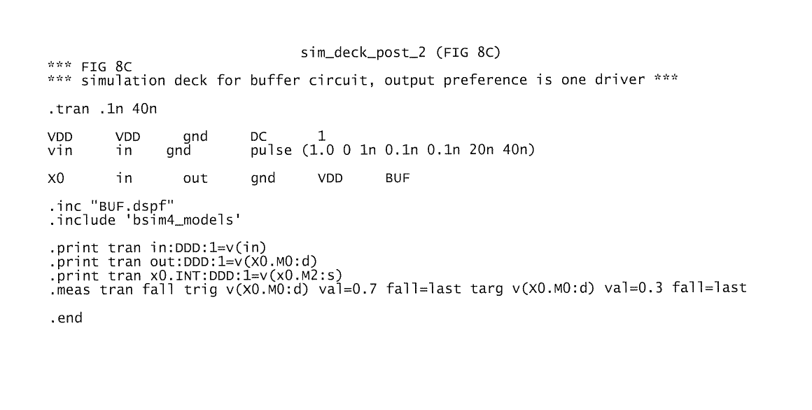

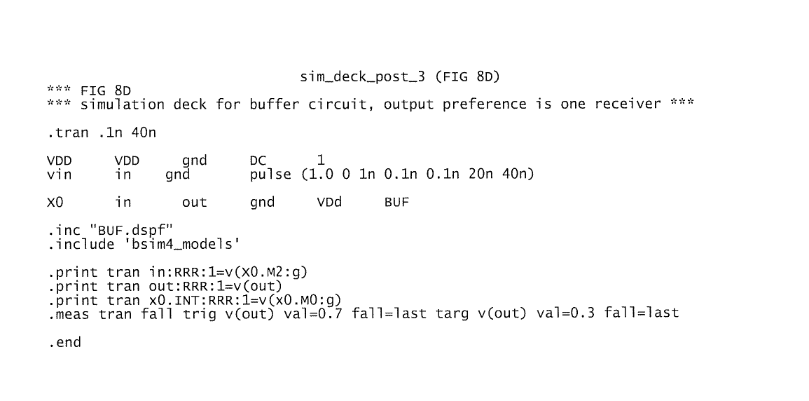

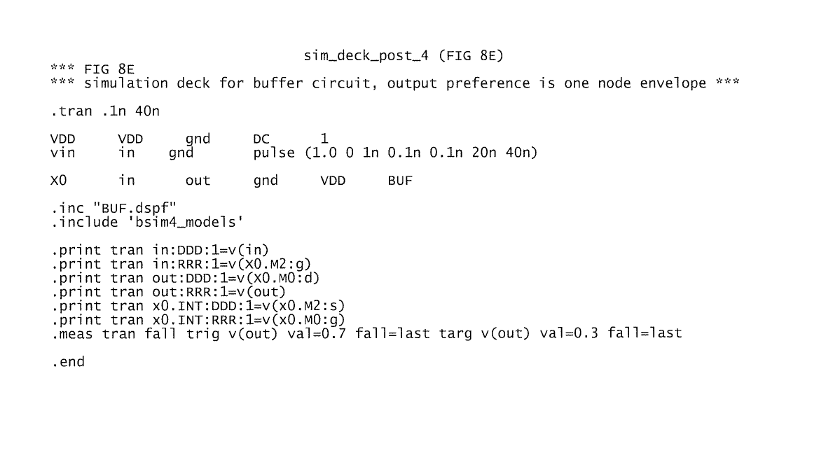

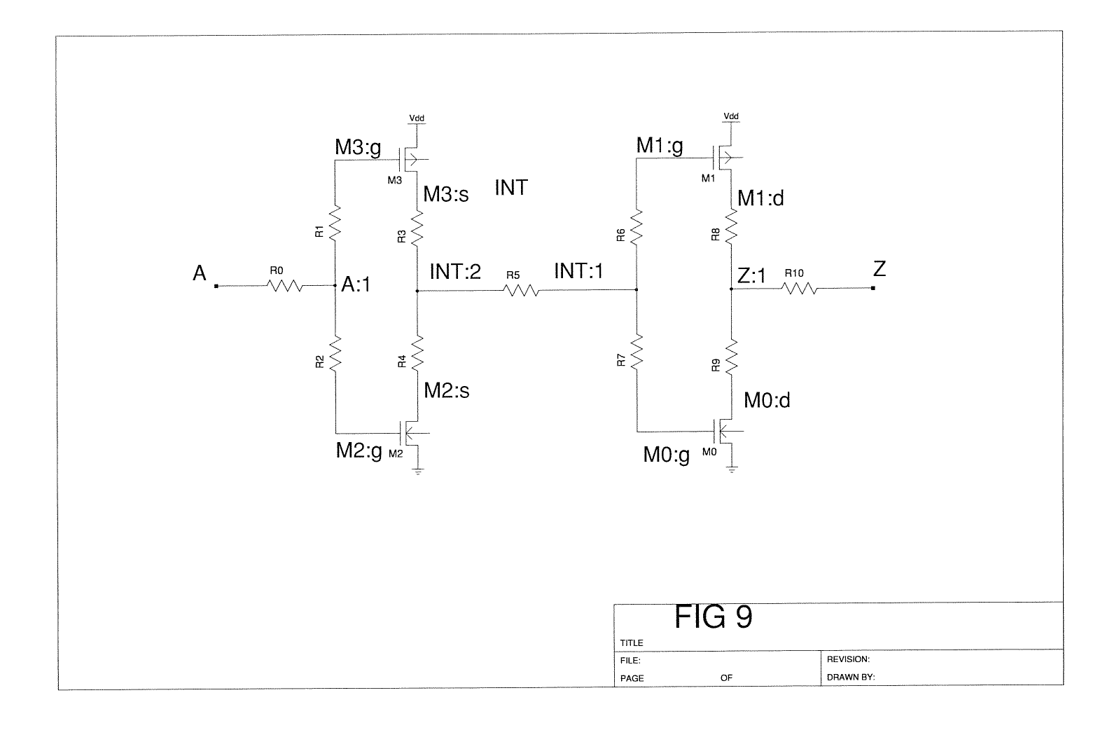

FIG. 8A shows a simulation deck that is used in a pre-layout circuit simulation for buffer circuit “BUF”. As shown in FIG. 8A, the simulation deck refers to a DSPF netlist file, a device model file, a statement for voltage supply VDD, a piece-wise linear specification of input stimulus “vin” that is applied to node “in”, and instance X0 of buffer circuit BUF, which provides an output signal at node “out”. FIG. 8A includes the following output statements for the simulation results:

.print tran v(in) v(out) v(x0.INT)
.meas tran fall trig v(out) val=0.7 fall=last targ v(out) val=0.3 fall=last

The .print statement outputs transient waveforms for nodes “in”, “out”, and internal node “X0.INT”. The .meas statement outputs a measurement of a signal transition time—from 0.7 volt to 0.3 volt—of the last falling edge of the net “out”.

FIG. 8B shows a generated simulation deck for a post-layout circuit simulation of buffer circuit “BUF”, when the user output preference is set to “pin”, according to one embodiment of the present invention. For this post-layout circuit simulation, an appropriate netlist may be, for example, the DSPF netlist of FIG. 4. In this embodiment, the following output statements are generated for this post-layout circuit simulation deck in place of the output statements of FIG. 8A:

.print tran in=v(in)
.print tran out=v(out)
.print tran x0.INT=v(x0.M0:g)
.meas tran fall trig v(out) fall=last targ v(out) val=0.3 fall=last

To generate these output statements, a method of the present invention first maps the post-layout nets to the pre-layout nets. For example, the pre-layout net “in” may be mapped to post-layout net “A” of instance X0 of buffer circuit “BUF”. Similarly, the pre-layout net “out” is mapped to post-layout net “Z”. The pre-layout net “X0.INT” is mapped to post-layout net “INT”. (See, e.g., in FIG. 4, the DSPF file for nets A, Z, and INT, and their associated circuit elements). Furthermore, in this example, as user output preference is set to “pin,” the method locates the pin-type subnets of each net and their corresponding post-layout hierarchical names. The post-layout names for the pin-type subnets are mapped to the pre-layout hierarchical names for output. For example, as shown in FIG. 4, the pin-type subnet for net “A” is node “A” (see the subnet corresponding to the IP directive). Node “A” is mapped to node “in” at the top level test bench. Thus, in the .print output statement, the method maps the pin node name to “in”. In FIG. 4, the pin-type subnet for net “Z” is node “Z” (see the subnet corresponding to the IP directive). Thus, node Z is assigned to “out” at the top level test bench. As mentioned above, the corresponding post-layout net for “X0.INT” is net “INT”. As there is no pin-type subnet in post-layout net INT, a subnet within the post-layout net “INT” is selected. The method of the present invention selects receiver node “M0:g”, which is an instance pin. In the output statement, the selected node “X0.M0:g” is assigned to hierarchical name “X0.INT”. For the measurement statement, the node voltage “v(out)” of the simulation deck of the pre-layout simulation of FIG. 8A is now replaced with the output pin “v(out)”, which is identical to the original node name.

FIG. 8C shows generated output statements for a post-layout circuit simulation of buffer circuit “BUF”, when the user output preference is set to “driver”, according to one embodiment of the present invention. Again, the DSPF netlist of FIG. 4 is used to illustrate this post-layout circuit simulation. The generated output statements replace the output statements of FIG. 8A. The generated output statements are:

.print tran in:DDD:1=v(in)
.print tran out:DDD:1=v(X0.M0:d)
.print tran x0.INT:DDD:1=v(x0.M2:s)
.meas tran fall trig v(X0.M0:s) val=0.7 fall=last targ v(X0.M0:s) val=0.3 fall=last

The mapping between the post-layout nets and the pre-layout nets has already been discussed above with respect to FIG. 8B. A method of the present invention determines a driver node of each post-layout net, as the user output preference specifies a single “driver” node. Therefore, as a driver node of post-layout net “X0.A” is pin “A”, that node A is assigned to the pre-layout name “in” at the top level test bench. In the output .print statement, the voltage “v(in)” is assigned to the voltage of node “in:DDD:1”, which specifies the first driver node of pre-layout node “in”. As one of the driver nodes of post-layout net “X0.Z” is “X0.M0:d”, which is an instance pin, the generated output statement assigns the voltage “v(X0.M0:d)” to the voltage of the node with the hierarchical name “out:DDD:1”, which specifies the first driver node of pre-layout node “out”. In other embodiments, the other driver node “X0.M1:d” of post-layout net “X0.Z” may be selected and used in the output statement. As there are two driver nodes in post-layout net “X0.INT”, “X0.M2:s” and “X0.M3:s”, which are instance pins, a method of the present invention may select “X0.M2:s” as the driver node for the output statement, although the choice of “X0.M3:s” for the output statement is equally valid. In the output statements, the voltage output “v(X0.M2:s) is assigned to the voltage of node “X0.INT:DDD:1”, which specifies the first driver node of pre-layout node “X0.INT”. For the measurement statement, the node voltage “v(out)” of the simulation deck of the pre-layout simulation of FIG. 8A is now replaced with the driver node voltage “v(X0.M0:d)”.

FIG. 8D shows generated output statements for a post-layout circuit simulation of buffer circuit “BUF”, when the user output preference is set to a single receiver node, according to one embodiment of the present invention. Again, the DSPF netlist of FIG. 4 is used to illustrate this post-layout circuit simulation. The generated output statements replace the output statements of FIG. 8A. The generated output statements are:

.print tran in:RRR:1=v(X0.M2:g)
.print tran out:RRR:1=v(out)
.print tran x0.INT:RRR:1=v(x0.M0:g)
.meas tran fall trig v(out) val=0.7 fall=last targ v(out) val=0.3 fall=last

The mapping between the post-layout nets and the pre-layout nets has already been discussed above with respect to FIG. 8B. A method of the present invention determines a receiver node of each post-layout net, as the user output preference is set to a single receiver node. Therefore, as a receiver node of post-layout net “X0.A” is pin “X0.M2:g”, the output statement assigns voltage node v(X0.M2:g) to the voltage of node “in.RRR:1,” which specifies the first receiver node of pre-layout node “in”. The other receiver node “X0.M3:g” of post-layout net “X0.A” is also a suitable choice. The pin subnet “Z” in the post-layout net “XO.Z” is a receiver node, and thus is mapped to node “out” at the top level test bench. In the output statements, the voltage “v(out)” is assigned to the voltage of node “out:RRR:1”, which specifies the first receiver node of pre-layout node “out”. As one of the receiver nodes in post-layout net “X0.INT” is “X0.M0:g”, which is an instance pin, the output statement assigns the voltage node “v(X0.M0:g) to the voltage of node “X0.INT:RRR:1”, which specifies the first receiver node of pre-layout node “X0.INT”. Receiver node “X0.M1:g” of post-layout net “X0.INT” is also a valid selection. For the measurement statement, the node voltage “v(out)” of the simulation deck of the pre-layout simulation of FIG. 8A is now replaced with the output pin “v(out)”, which is identical to the original node name.

FIG. 8E shows the generated output statements for a post-layout circuit simulation of circuit buffer “BUF”, when the user preference is set to “envelope”, according to one embodiment of the present invention. Again, the DSPF netlist of FIG. 4 is used to illustrate this post-layout circuit simulation. The generated output statements replace the output statements of FIG. 8A. The generated output statements are:

.print tran in:DDD:1=v(in)
.print tran in:RRR:1=v(X0.M2:g)
.print tran out:DDD:1=v(X0.M0:d)
.print tran out:RRR:1=v(out)
.print tran x0.INT:DDD:1=v(x0.M2:s)
.print tran x0.INT:RRR:1=v(x0.M0:g)
.meas tran fall trig v(out) val=0.7 fall=last targ v(out) val=0.3 fall=last

The mapping between the post-layout nets and the pre-layout nets has already been discussed above with respect to FIG. 8B. In addition, a method of the present invention providing output statements for the “envelope” user preference determines a driver node and a receiver node using the methods already described above for determining pins, driver nodes and receiver nodes of each post-layout net in conjunction with FIGS. 8B, 8C, and 8D, respectively. For net “in”, the driver node voltage “v(in)” is assigned to the voltage of node “in:DDD:1” and the receiver node voltage “v(X0.M2:g)” is assigned to the voltage of node “in:RRR:1” in the output statements. (The receiver node voltage “v(X0.M3:g)” may also be assigned to the voltage of node “in:RRR:1”.) For net “out”, the driver node voltage “v(X0.M0:d)” is assigned to the voltage for node “out:DDD:1” and the receiver node voltage “v(out)” is assigned to the voltage of node “out:RRR:1”. (The driver voltage “v(X0.M1:d)” may be assigned to the voltage of the node “out:DDD:1”.) For net “X0.INT”, the driver node voltage “v(X0.M2:s)” is assigned to the voltage of node “X0.INT:DDD:1” and the receiver node voltage “v(X0.M0:g)” is assigned to the voltage of node “X0.INT:RRR:1”. (The driver node voltage v(X0.M3:s) may also be assigned to the voltage of node “X0.INT:DDD:1” and the receiver node voltage “v(X0.M1:g)” may also be assigned to the voltage of node “X0.INT:RRR:1”). For the measurement statement, the node voltage “v(out)” of the simulation deck of the pre-layout circuit simulation of FIG. 8A is now replaced with the output pin “v(out)”, which is identical to the original node name.

FIG. 9 is a schematic circuit of the post-layout buffer circuit BUF, which illustrates using a path-tracing program to identify subnets of post-layout nets, according to one embodiment of the present invention. The netlist for the schematic circuit of FIG. 9 is set forth in the post-layout DSPF netlist of FIG. 4. The post-layout schematic circuit of FIG. 9 includes both the pre-layout circuit elements and post-layout parasitic circuit elements. According to one embodiment of the present invention, for each post-layout net, a path-tracing program selects a resistor element in the net and then identifies and records all resistors in the net that are connected to the selected resistor. The path-tracing program records the resistors and their associated subnets. The procedure is repeated for all post-layout nets until all resistors are identified and recorded. In like manner, the path-tracing program identifies and records all capacitors in each net and their associated subnets. For buffer circuit “BUF”, the path-tracing program searches three post-layout nets A, INT and Z. Post-layout net A includes resistors R0, R1, R2 and subnets A, A:1, M2:g, and M3:g. Post-layout net INT includes resistors R3, R4, R5, R6, R7 and subnets M2:s, M3:s, INT:1, INT:2, M0:g and M1:g. Post-layout net Z includes resistors R8, R9, R10 and subnets M0:d, M1:d, Z:1 and Z. The path-tracing program further determines whether each subnet identified is a pin, an instance pin, or a sub-node. For each pin, the subnet may be further determined as a driver node or a receiver node. Subnets A and Z are pins and have the same names as their respective post-layout nets. Subnet A is a driver node and subnet Z is a receiver node. Subnets M0:g, M1:g, M2:g and M3:g are instance pins that are receiver nodes. Subnets M0:d, M1:d, M2:s and M3:s are instance pins that are driver nodes. Subnets A:1, INT:1, INT:2 and Z:1 are each a sub-node that is neither a pin or an instance pin.

FIG. 10 is a schematic circuit of the post-layout buffer circuit BUF, which illustrates node-matching using element names to identify subnets of post-layout nets, according to one embodiment of the present invention. The netlist for buffer circuit “BUF” is set forth in the post-layout DSPF netlist of FIG. 5. Unlike the post-layout schematic circuit of FIG. 9, which uses pre-layout node names in some nets, the post-layout schematic circuit of FIG. 10 uses index numbers which are independent of pre-layout node names. As the element names are preserved between the pre-layout and post-layout netlists, pre-layout node names and post-layout node names may be mapped through element names and node connectivity. According to one embodiment of the present invention, a method uses a path-tracing program to first identify each post-layout net. Post-layout net A includes subnets A, F1, F2, and F3 and is connected to gate terminals of transistors M2 and M3. Post-layout net INT includes subnets F4, F5, F6, F7, F8, and F9 and is connected to the gate terminals of transistors M0 and M1 and drain terminals of transistors M2 and M3. Post-layout net Z includes subnets F10, F11, F12, and Z and is connected to the drain terminals of transistors M0 and M1. As pre-layout net IN is connected to the gate terminals of M2 and M3, pre-layout net IN matches post-layout net A. Similarly, as pre-layout net INT connects to the gate terminals of transistors M0 and M1 and the drain terminals of transistors M2 and M3, pre-layout net INT matches post-layout net INT. As pre-layout net OUT is connected to the drain terminals of transistors M0 and M1, pre-layout net OUT matches post-layout net Z.

Therefore, to achieve the advantages stated above, one method carries out the following steps in a preprocessor to a circuit simulator, in a post-processor to a circuit simulator, or as part of a circuit simulator:
(a) providing a post-layout netlist for circuit simulation;
(b) providing a pre-layout netlist corresponding to the post-layout netlist, the pre-layout netlist including output statements;
(c) receiving user preference regarding data output for a post-layout circuit simulation;
(d) searching the post-layout netlist for all the parasitic circuit elements and subnets associated with each net in the pre-layout netlist;
(e) matching net names between the post-layout netlist and the pre-layout netlist, using either post-layout node names or post-layout element names; and
(f) when carrying out the method in the preprocessor, generating hierarchical output statements for the post-layout circuit simulation based on user preference and the pre-layout output statements, thereby producing a reduced output simulation result database based on the user preference;
   (ii) when carrying out the method in the post-processor, generating a reduced hierarchical output database based on the user preference and a post-layout simulation result database; and
   (iii) when carrying out the method in the circuit simulator, generating output statements for the circuit simulation based on the user preference and the pre-layout output statements, thereby causing generation of a reduced circuit simulation result database.

FIG. 1 is a block diagram showing a method in a preprocessor of a circuit simulator for reducing the size of a post-layout simulation output database, according to one embodiment of the present invention. In FIG. 1, post-layout netlist 100 contains pre-layout circuit elements and post-layout parasitic circuit elements. Simulation deck or test bench 101 contains simulation input stimuli and output statements for the circuit simulator. The output statements may specify nodes using pre-layout net names. Preference file 102 includes user specified output data preference. For example, in preference file 102, a user may specify output of leading driver nodes, trailing receiver nodes, and envelope signals based on the leading driver nodes and the trailing receiver nodes. Post-layout circuit simulation results reduction program 103 receives post-layout netlist 100, simulation deck 101 and user preference file 102 to generate simulation deck 104, which includes generated output statements that may specify nodes using post-layout net names. Simulation deck 104 and post-layout netlist 100 are read into the circuit simulator as input files for a post-layout simulation 105. The circuit simulator then produces reduced simulation output database 106, which may be hierarchical.

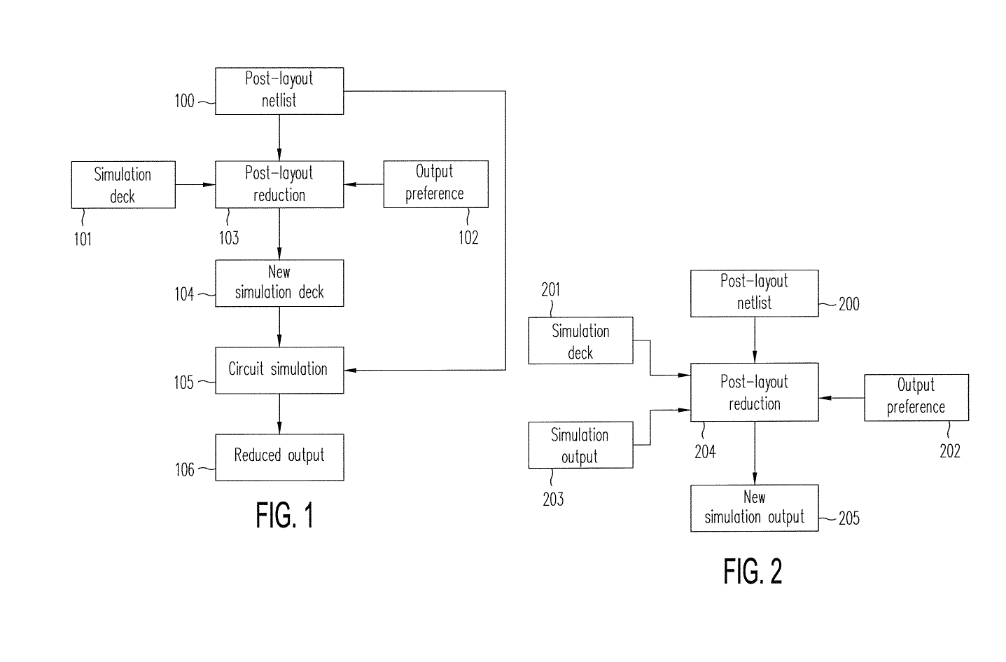

FIG. 2 is a block diagram showing a method in a post-processor for reducing a post-layout simulation output database, according to one embodiment of the present invention. In FIG. 2, post-layout netlist 200 contains pre-layout circuit elements and post-layout parasitic circuit elements. Simulation deck or test bench 201 contains simulation input stimuli and output statements for the circuit simulator. The output statements may specify nodes using post-layout net names. Preference file 202 includes user specified output data preference. For example, in preference file 202, a user may specify output of leading driver nodes, trailing receiver nodes, and envelope signals based on the leading driver nodes and the trailing receiver nodes. Circuit simulator output database 203 contains a post-layout circuit simulation result database. Post-layout circuit simulation result reduction program 204 receives post-layout netlist 200, simulation deck 201, preference file 202, and circuit simulation result database 203 to generate reduced circuit simulation results database 205, which may have a reduced size, relative to circuit simulation output database 203, and may also be hierarchical.

The detailed description herein is provided to illustrate specific embodiments of the present invention and is not intended to be limiting. Numerous modifications and variations within the scope of the invention are possible. The present invention is set forth in the following claims.

I claim:

1. A method for reducing output data from a post-layout circuit simulation, comprising executing in a processor instructions for:
receiving a post-layout netlist, which includes circuit elements that are assigned pre-layout circuit element names, parasitic circuit elements, and nets comprising subnets interconnecting the circuit elements and the parasitic circuit elements;
receiving a simulation deck which includes one or more output statements;
receiving data output preferences for the post-layout circuit simulation;
tracing the subnets to determine one or more attributes of each subnet; and
generating one or more output statements to be included in the simulation deck, based on the attributes of the subnets, the output statements in the first simulation deck, and the data output preferences.

2. The method of claim 1, wherein the post-layout netlist is specified according to a DSPF format or a SPICE-compatible netlist format.

3. The method of claim 1, wherein one of the attributes of the subnet is a pin driver node, a pin receiver node, an instance pin driver node, an instance pin receiver node, or a sub-node.

4. The method of claim 3, wherein said tracing the subnets to determine one or more attributes of each subnet comprises determining whether a subnet is an instance pin driver node or an instance pin receiver node according to a terminal of the circuit element included in the subnet.

5. The method of claim 3, wherein the attributes of each subnet are determined based on node connectivity.

6. The method of claim 3, wherein the data output preferences specify one or more of the subnets selected from a pin node, a driver node, a receiver node, or a sub-node for output.

7. The method of claim 6, wherein one or more of the generated output statements specify one or more of the subnets selected from a pin node, a driver node, a receiver node, or a sub-node for output.

8. The method of claim 6, wherein one or more of the generated output statements specify an envelope waveform for output.

9. The method of claim 2, wherein the attributes of each subnet is determined from the DSPF format netlist.

10. The method of claim 1, wherein the output statements of the simulation deck are specified using pre-layout node names, and wherein said generating one or more output statement comprises mapping the pre-layout node names to the subnets in the post-layout netlist.

11. The method of claim 10, wherein said mapping comprises matching the pre-layout node names to names of the subnets in the post-layout netlist.

12. The method of claim 10, further comprising receiving a pre-layout netlist.

13. The method of claim 12, wherein said mapping comprises determining the subnets from the pre-layout netlist, node connectivity and names of both the circuit elements and the parasitic elements in the post-layout netlist.

14. The method of claim 10, wherein the generated output statements include hierarchical names of the subnets that match hierarchical pre-layout node names.

15. The method of claim 1, further comprising providing a hierarchical simulation result database.

16. The method of claim 1, further comprising performing the post layout circuit simulation in a circuit simulator using the post layout netlist and the simulation deck.

17. The method of claim 16, wherein the method is carried out in a pre-processor to the circuit simulator.

18. The method of claim 16, wherein the method is carried out in the circuit simulator.

19. The method of claim 1, further comprising receiving a post layout circuit simulation result database.

20. The method of claim 19, further comprising reducing a size of the post layout circuit simulation result database based on the generated output statements in a post-processor of the circuit simulator.
